(19) United States
(12) Patent Application Publication
(10) Pub. No.: US 2011/0206085 A1
(43) Pub. Date: Aug. 25, 2011

(54) METHOD FOR INSTALLING GEOTHERMAL ENERGY PROBES AND GEOTHERMAL ENERGY PROBE ARRANGEMENT

(75) Inventor: Andreas Hagedorn, Olpe (DE)

(73) Assignee: Tracto-Technik GmbH & Co. KG, Lennestadt (DE)

(21) Appl. No.: 13/026,847

(22) Filed: Feb. 14, 2011

(30) Foreign Application Priority Data
Feb. 19, 2010 (DE) 10 2010 008 710.6

(51) Int. Cl. G01K 13/00; B23P 19/00

(52) U.S. Cl. 374/136; 29/428; 374/E13.001

(57) ABSTRACT

Geothermal energy probes, in particular at least a first group of two to five geothermal energy probes, are installed in the ground from a starting point in the radial direction such that the corresponding spreading angle between adjacent geothermal energy probes is at least 72° and the corresponding differential inclination angle is at least 10°, wherein the differential inclination angle continuously increases or decreases from one geothermal probe of the first group to the next.

### CROSS-REFERENCES TO RELATED APPLICATIONS

This application claims the priority of German Patent Application, Serial No. 10 2010 008 710.6, filed Feb. 19, 2010, pursuant to 35 U.S.C. 119(a)-(d), the content of which is incorporated herein by reference in its entirety as if fully set forth herein.

### BACKGROUND OF THE INVENTION

The present invention relates to a method for installing geothermal energy probes and to a geothermal energy probe arrangement.

The following discussion of related art is provided to assist the reader in understanding the advantages of the invention, and is not to be construed as an admission that this related art is prior art to this invention.

The use of geothermal energy for energy generation has increased significantly over the past years. Geothermal energy is typically generated either by using thermal energy probes or geothermal energy collectors installed in the ground. In the presently most widely used method today for using geothermal energy, a number of vertical bore holes arranged with a defined spacing from one another, in which individual geothermal energy probes are inserted, are installed in a defined area, for example a garden of a single family dwelling. Disadvantageously, with this type of installation, geothermal energy probes can only be installed in areas which are not built-up, because a corresponding drilling rig must be positioned at all locations where a geothermal energy probe is to be inserted. Introduction of a plurality of vertical geothermal energy probes is also relatively expensive, because the drilling rig used to drill the bore hole in the ground and insert the probe into the bore hole must be aligned anew at each of these locations. Transporting the drilling rig from the individual locations may also cause significant damage to the vegetation which has to be repaired later.

These disadvantages have lead to the development of a method where the geothermal energy probes are introduced into the ground radially, i.e., in different directions and with different inclination angles, from a single point, for example an excavated starting shaft. This type of star-shaped installation of geothermal energy probes is generally referred to as “Geothermal Radial Drilling” (GRD). This method has the significant advantage that the drilling rig must only be positioned at a single location from which the rig then introduces the bore holes in the ground with different directions. Due to the inclined arrangement of the thermal energy probes in the ground, these probes can moreover extend into regions of the ground where the surface has been built up.

Geothermal energy collectors consist of one or several probes having a pattern with several curvatures, forming a two-dimensional arrangement. They have frequently a meander-shaped pattern wherein the individual strands of the geothermal energy probes run parallel. Geothermal energy collectors are typically installed with an open trench process. To this end, a more or less deep excavation pit is excavated in the entire region of the ground provided for the heat-exchange, and the geothermal energy collector is installed therein with a more or less horizontal orientation. Because the entire lengths of the geothermal energy collectors, unlike geothermal energy probes, are located in layers near the ground surface, where the temperature difference between the ground and the heat transfer fluid circulating inside the geothermal energy collectors is relatively small during cold spells, the available lower specific heat exchange power of the geothermal energy collectors must be compensated by using geothermal energy collectors with a length greater than that of geothermal energy probes.

Geothermal energy probes may not only be used to generate heat, but also to cool the air in buildings during the summer through heat exchange from the geothermal energy probes in the ground, when the temperature of the air and inside the buildings connected to the geothermal energy system is significantly higher than the temperatures in the ground.

One problem that has to be taken into account when designing geothermal energy fields where several geothermal energy probes are installed with a relatively small spacing therebetween, is the reduced energy removal efficiency caused by the drift of the cooled (or heated) groundwater due to groundwater flow. Regardless if the groundwater flow in the corresponding region has a stable direction or an instable direction, the individual geothermal energy probes produce (heat or) cold streaks which can flow to other geothermal energy probes in the probe field and thereby significantly weaken the thermal efficiency of these geothermal energy probes exposed to the flow.

To reduce the mutual interaction between the geothermal energy probes, a greater spacing between the individual geothermal energy probes and/or a greater length of the geothermal energy probes are typically selected in a vertical installation than would otherwise be required based on a computation which takes into account the dimensioning parameters (in particular the energy requirement and temperature gradients in the ground). Moreover, if the groundwater flow is directionally stable, the location of the individual geothermal energy probes can be selected such that groundwater whose temperature was changed by one of the geothermal energy probes does not flow towards another geothermal energy probe, or only to very few geothermal energy probes in the geothermal energy field. Such arrangement of the locations, however, can in many situations not be reliably determined because, on the one hand, the groundwater flow frequently lacks the required directional stability and, on the other hand, the drift of the groundwater cannot be predicted with sufficient accuracy.

The corresponding measures for reducing the mutual interference between the geothermal energy probes of a radial geothermal energy probe field may involve increasing the separation angle between the individual geothermal energy probes and/or lengthening the probes.

The individual parallel probe strands of geothermal energy collectors are typically installed with a greater spacing therebetween, or the overall collector surface is increased or is no longer installed exactly horizontally, but rather with a certain slope.

An increase of the spacing between the individual geothermal energy probes in a vertical field requires a larger area available for the installation, which is frequently not available. The same applies to an increase in the collector surface of a geothermal energy collector. An increase in the length of the geothermal energy probes furthermore requires deeper bore holes, which is associated with a not insignificant increase in the installation costs.

It would therefore be desirable and advantageous to obviate prior art shortcomings and provide a geothermal energy probe arrangement and an improved method for installing geothermal energy probes where the mutual thermal interference between the geothermal energy probes is reduced.

### SUMMARY OF THE INVENTION

The present invention resolves prior art problems by reducing the likelihood of a mutual thermal interference between geothermal energy probes of a geothermal energy probe arrangement by introducing the geothermal energy probes radially into the ground, wherein a greatest possible center spacing between the individual geothermal energy probes within a predetermined range is desired. The positional configuration of the geothermal energy probes in the ground is selected such that at most two geothermal energy probes can be brought into an overlapping relationship through a geometric rotation of the geothermal energy probe arrangement about an imaginary axis having an arbitrary orientation in three-dimensional space.

According to one aspect of the present invention, a method for installing geothermal energy probes includes introducing at least one group having two to five geothermal energy probes into the ground from a starting point in a radial direction with a horizontal spreading angle between adjacent geothermal probes of at least 72° and a differential inclination angle between adjacent geothermal probes of at least 10°, wherein the differential inclination angle continuously increases or decreases from one geothermal probe of the first group to the next.

According to another aspect of the present invention, a corresponding geothermal energy probe arrangement includes at least a one group of two to five geothermal energy probes extending in ground from a starting point in a radial direction with a horizontal spreading angle between adjacent geothermal energy probes of at least 72° and a differential inclination angle between adjacent geothermal probes of at least 10°, wherein the differential inclination angle continuously increases or decreases from one geothermal probe of the first group to the next.

With the positional configuration according to the invention, a smallest possible mutual thermal interference between the up to five geothermal energy probes in the group can be achieved independent of the direction and stability of the groundwater flow, because groundwater whose temperature was changed by one of the geothermal energy probes can flow against at most one second geothermal energy probe of this group and affect the efficiency of that one second probe. The measures known in the art and used to compensate for the loss of efficiency due to a mutual thermal interference between the individual geothermal energy probes can thereby be entirely eliminated or at least reduced. As a result, the costs associated with the installation of the geothermal energy probe field can also be reduced.

The term spreading angle refers to the projection of the angle between two adjacent geothermal energy probes onto a plane parallel to the ground surface. The term inclination angle refers to the smallest angle subtended between the thermal energy probe and the ground surface. The differential inclination angle refers to the difference between the inclination angles between two adjacent geothermal energy probes.

With the positional configuration of the geothermal energy probes, an angular spacing, i.e., the angle formed between two adjacent geothermal energy probes, of at least about 25° can be ensured

In one embodiment of the method of the invention and of the geothermal energy probe arrangement of the invention, the spreading angle between adjacent geothermal energy probes is as large as possible. As a result, a spreading angle of 72° between each of two adjacent geothermal energy probes is attained when using a total of five geothermal energy probes of the first group, an angle of 90° when using a total of four thermal energy probes of the group, an angle of 120° when using three thermal energy probes of the group, and an angle of 180° when using two thermal energy probes of the group.

Advantageously, the individual differential inclination angles formed between adjacent geothermal energy probes of the group should preferably have identical values. These can therefore be determined from the formula x=(steepest inclination angle−flattest inclination angle):(number of probes of the group−1).

In another advantageous embodiment of the invention and of the geothermal energy probe arrangement of the invention, the inclination angle of the geothermal energy probes may be between 30° and 70°. When using a total of five geothermal energy probes of the group, the required minimum differential inclination angle is 10°. When using less than five geothermal energy probes in each group, this angle can also be selected to be larger. It is not necessary for the inclination angle of the flattest geothermal energy probe to be 30° and for the inclination angle of the flattest geothermal energy probe to be 70°.

In another advantageous embodiment of the method of the invention, a second group of two to five geothermal energy probes is introduced into the ground from the starting point in a radial direction such that the respective spreading angle between adjacent geothermal probes of the (second) group is at least 72° and the respective differential inclination angle is at least 10°, wherein the increase or decrease of the inclination angle is continuous.

A geothermal energy probe arrangement according to the invention then has a second group of two to five geothermal energy probes which are introduced into the ground from the starting point in a radial direction such that the respective spreading angle between adjacent geothermal probes of this group is at least 72° and the respective differential inclination angle is at least 10°, wherein the increase or decrease of the inclination angles is continuous.

With this embodiment of the method of the invention and of the geothermal energy probe arrangement of the invention, two groups with a total of up to five geothermal energy probes can be combined with one another, whereby both the mutual thermal interference between the geothermal energy probes of the respective groups as well as the mutual thermal interference between the two groups can be kept as small as possible. In this way, an available region of the ground can be used for installing the geothermal energy probes with optimal efficiency.

Advantageously, in the second group, the spreading angle between adjacent geothermal energy probes is selected to be as large as possible, the differential inclination angles between the adjacent geothermal energy probes are selected to be identical and/or the inclination angles of the geothermal energy probes are selected to be between 30° and 70°.

In another advantageous embodiment of the invention and of the geothermal energy probe arrangement of the invention, the horizontal spreading angle between the geothermal energy probes of the two groups with the flattest inclination angle is 180°. With this arrangement, the thermal interference between the individual geothermal energy probes can be reduced to a minimum even when using up to ten geothermal energy probes, in that at most only two rotationally symmetric cones of the geothermal energy probes about an arbitrary imaginary axis can be brought into an approximate overlap. The probes can therefore be advantageously installed from one point with a geometry that prevents a complete geometric rotational overlap. As a result, cooling or heating streaks which originate at one or several geothermal energy probes and drift due to groundwater flow can then at most impact only a single second probe in the arrangement.

It will be understood that additional geothermal energy probes, in addition to the up to 10 geothermal energy probes of the two groups, can be installed in the geothermal energy probe arrangement. However, this may possibly amplify the thermal mutual interference between the geothermal energy probes, so that as a result the overall performance of the geothermal energy probe arrangement may increase only slightly. Each individual situation should therefore be evaluated to determine if the overall performance of the geothermal energy probe arrangement can be increased at all by installing additional geothermal energy probes, and—if this is the case—such potentially small increase in the performance justifies the significant additional expenses for installing the additional geothermal energy probes.

Because an optimum cost-benefit factor can be attained with the method of the invention and the geothermal energy probe arrangement of the invention when using ten geothermal energy probes, in a preferred embodiment of the method of the invention and the geothermal energy probe arrangement of the invention, the required total length of the geothermal energy probes needs to be determined by taking into consideration the use of ten geothermal energy probes. This overall length of the geothermal energy probes of the geothermal energy probe arrangement can be distributed uniformly among the up to ten geothermal energy probes, or geothermal energy probes having different lengths can be used.

In the latter situation, the geothermal energy probes which are introduced in the ground with a flatter inclination angle are designed to be shorter than those with a steeper inclination angle. The amount by which the length of the individual geothermal energy probes differs from the average value (i.e., shorter or longer) may be the same, so that the geothermal energy probes with the flatter inclination angles are shorter by about the same amount as the geothermal energy probes with the steeper inclination angles are longer. Furthermore, the total amount by which the flatter geothermal energy probes are shorter than the steeper geothermal energy probes may be the same even if no particular ratio of the length between the individual geothermal energy probes is required. Moreover, the flattest of the geothermal energy probes of a group may be shorter than the average value by the same amount as the steepest geothermal energy probe is longer than the average value. A corresponding relationship can also exist for the geothermal energy probes with the second flattest and the second steepest inclination angles, respectively. In general, the two geothermal energy probes of a group with the flattest inclination angles may have the same length and be thereby shorter than the average value by an amount which corresponds to the amount by which the two steepest geothermal energy probes of a group are longer than the average value.

The method of the invention and the geothermal energy probe arrangement of the invention is particularly suited for the use of geothermal energy for heating buildings, for cooling buildings by dissipating thermal energy into the ground (building cooling), for physical, chemical and/or biological immobilization of contamination below ground, for decontaminating the ground from a central point, for water catchment and generating water pressure by installing several wells from a central point, in particular if the drilling depth is limited or the ground in this region has a low transmissibility, and for stabilizing slopes by using otherwise known physical and/or chemical methods.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIGS. 1a to 1e show various positional configurations of up to five geothermal energy probes of a geothermal energy probe arrangement;

FIG. 2 shows an evaluation of the efficiency of the geothermal energy probe arrangements according to FIGS. 1a to 1e;

FIG. 3 shows a geothermal energy probe arrangement according to the invention with a total of five geothermal energy probes in a side view;

FIG. 4 shows the geothermal energy probe arrangement of

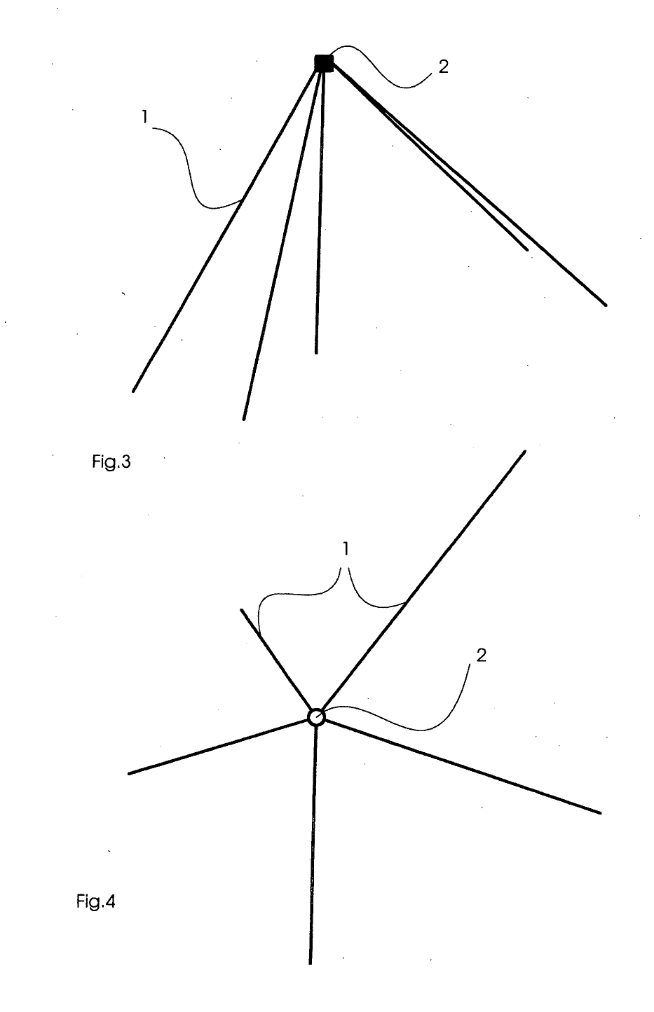

FIG. 3 in a top view;

FIG. 5 shows the geothermal energy probe arrangement of FIG. 3 in a stereographic projection;

FIG. 6 shows a geothermal energy probe arrangement according to the invention in a second embodiment with a total of ten geothermal energy probes in a side view;

FIG. 7 shows the geothermal energy probe arrangement of

FIG. 6 in a top view; and

FIG. 8 shows the geothermal energy probe arrangement of FIG. 6 in a stereographic projection.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

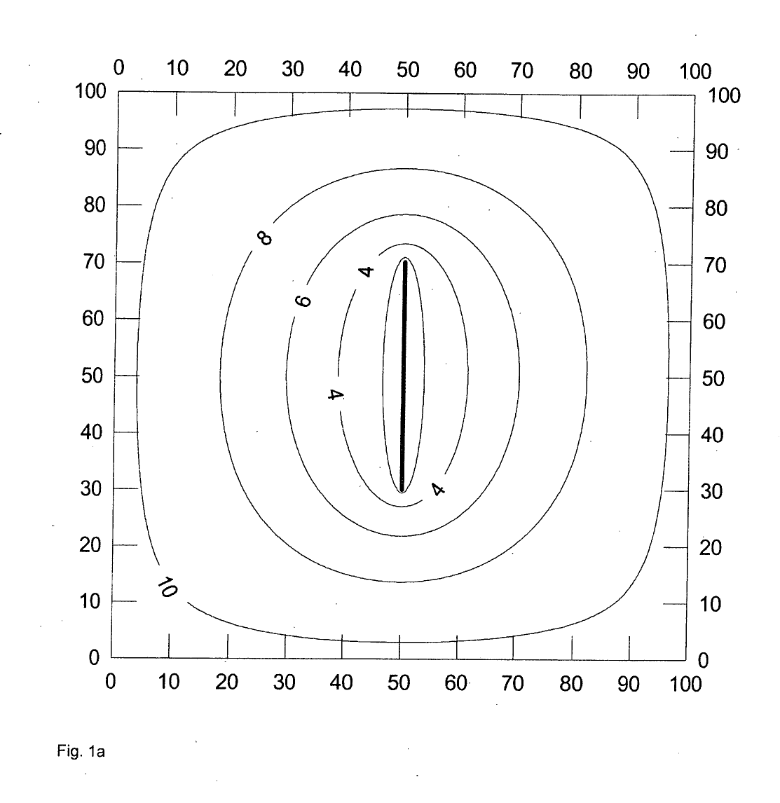

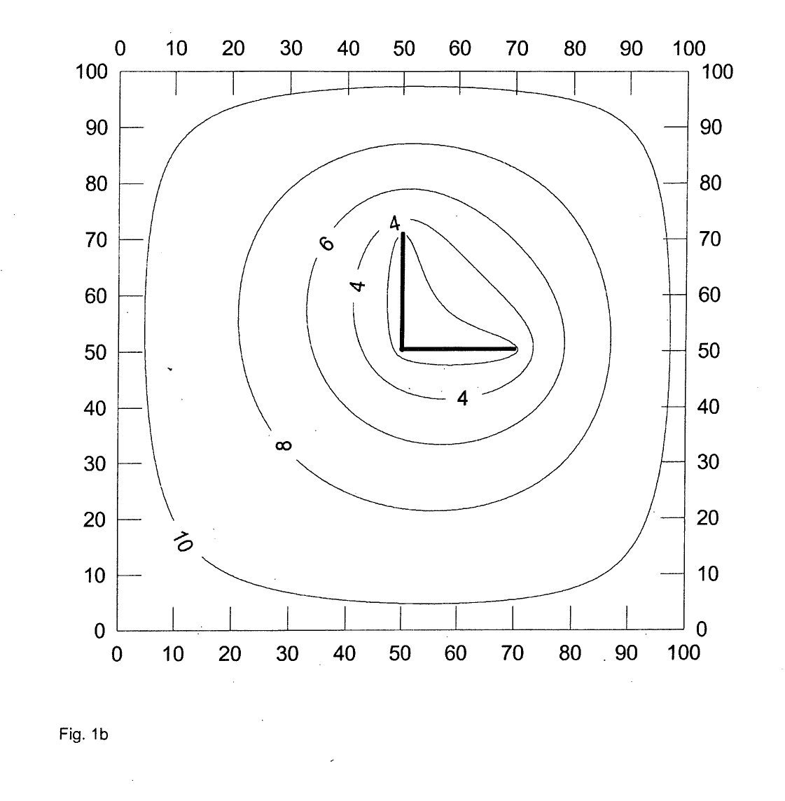

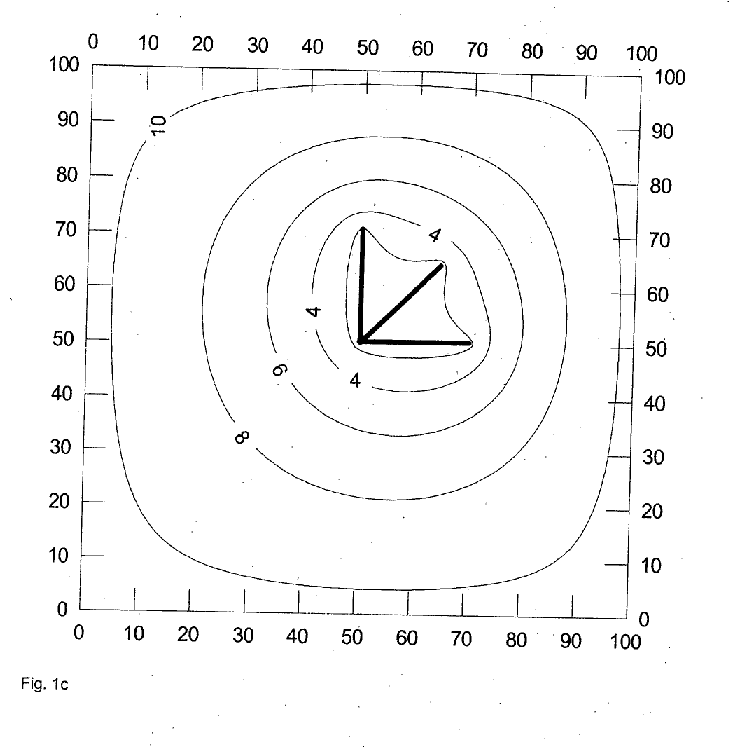

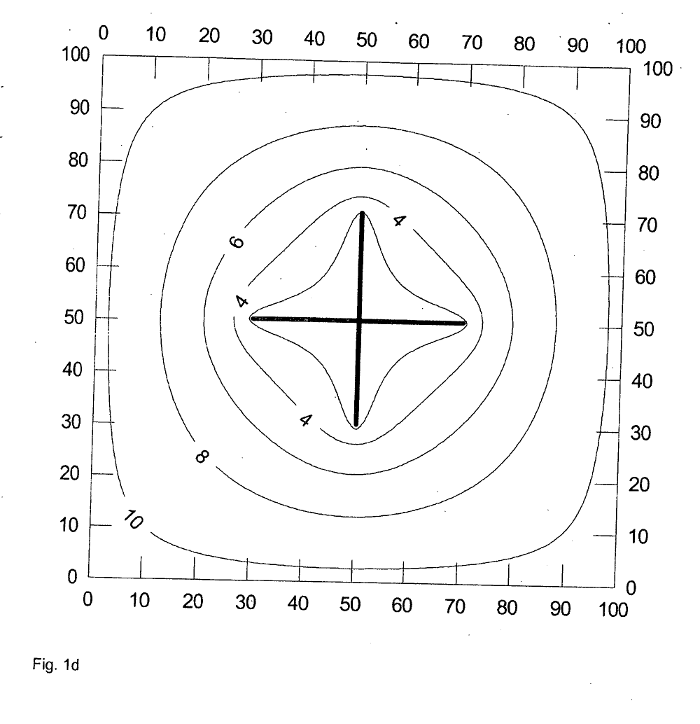

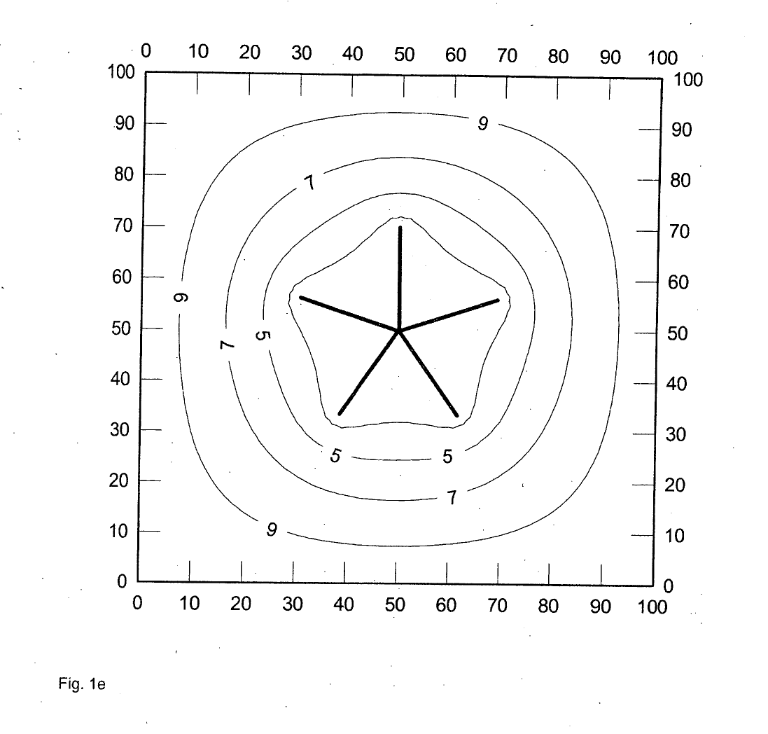

Turning now to the drawing, and in particular to FIGS. 1a to 1e, there are shown different positional configurations of geothermal energy probe arrangements with up to five geothermal energy probes which were simulated to investigate the mutual thermal influence of geothermal energy probes. A computational simulation program was used.

A starting and reference point is the positional configuration illustrated in FIG. 1a, where two geothermal energy probes are arranged with a spreading angle of 180° and horizontally aligned with respect to each other. A mutual thermal interference between the two geothermal energy probes could not be detected with the defined test parameters (length of the geothermal energy probes: each 20 m, temperature difference between the surrounding temperature and the temperature of the geothermal energy probe: 9.5 K, temperature difference between the isotherms: 2 K). As a result, each of the geothermal energy probes has a power output of 1,561 kJ/day.

FIG. 1b shows an alternative positional configuration of likewise two geothermal energy probes which, however, have a spreading angle of 90°. In the simulation of this geothermal energy probe arrangement, a mutual thermal interference was detected compared to the geothermal energy probe arrangement of

FIG. 1a, which is identical for both geothermal energy probes. A power output of only 1,337 kJ/day was determined for each of the two probes.

FIG. 1c shows a geothermal energy probe arrangement with a total of three geothermal energy probes installed with a respective spreading angle of 45°. Compared to the example of FIG. 1b, the mutual thermal interference increases even more and is a greater for the center geothermal energy probe of the three geothermal energy probes than for the two outer geothermal energy probes. A power output of 1,220 kJ/day was determined for the two outer probes, whereas a power output of 594 kJ/day was determined for the center geothermal energy probe.

In the exemplary positional configuration of FIG. 1d with a total of four geothermal energy probes installed with a respective spreading angle of 90°, the power output of the individual geothermal energy probes decreases further as a result of the mutual interference; however, the ground is thermally uniformly loaded, as expressed in an identical power output from all four geothermal energy probes. A power output of 986 kJ/day was determined for these probes.

FIG. 1e illustrates a uniform distribution of a total of five geothermal energy probes with a spreading angle of 72° between each of two probes. Again, a decrease in the power output of the individual geothermal energy probes can be detected, wherein the power output is again identical for all geothermal energy probes. An identical power output of 986 kJ/day was determined for each of these probes.

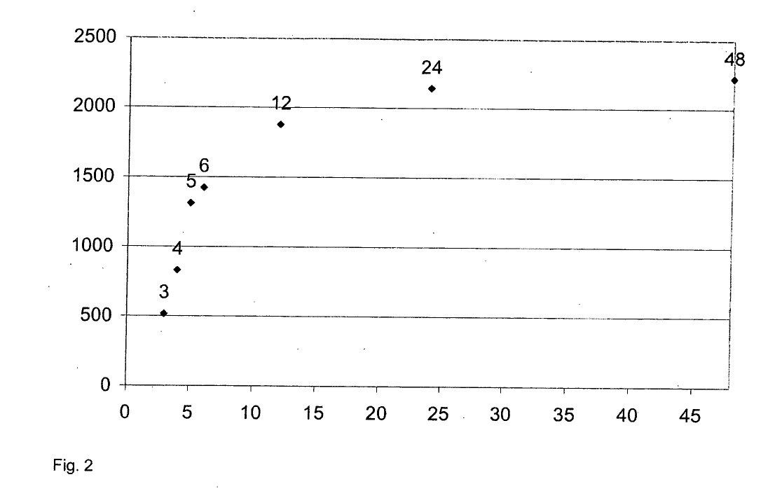

FIG. 2 shows the increase in power output from the respective geothermal energy probe arrangement of the examples illustrated in FIGS. 1b to 1e normalized to the situation of FIG. 1a. Also shown are the results for a corresponding positional configuration with a total of 6, 12, 24 and 48 geothermal energy probes. A positional configuration with uniform spreading angles was also selected for these additional exemplary embodiments. As can be seen, a significant increase of the total power output from the geothermal energy probe arrangement can be obtained when using a total of up to five geothermal energy probes; thereafter, the total power increases only slightly and asymptotically towards a limited value.

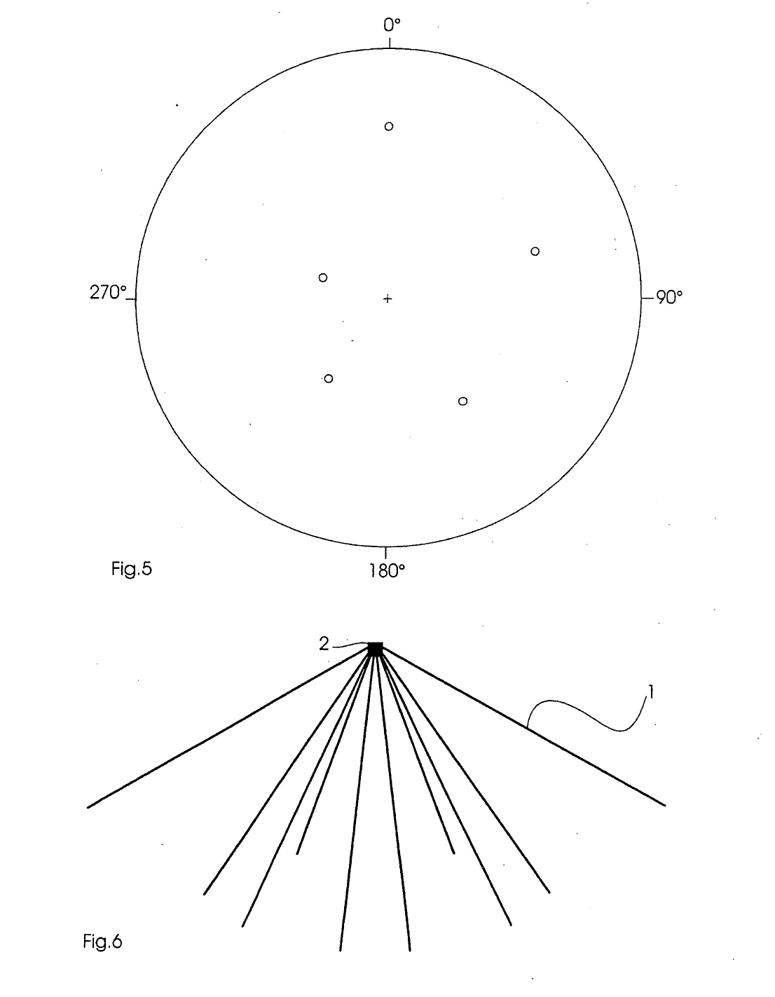

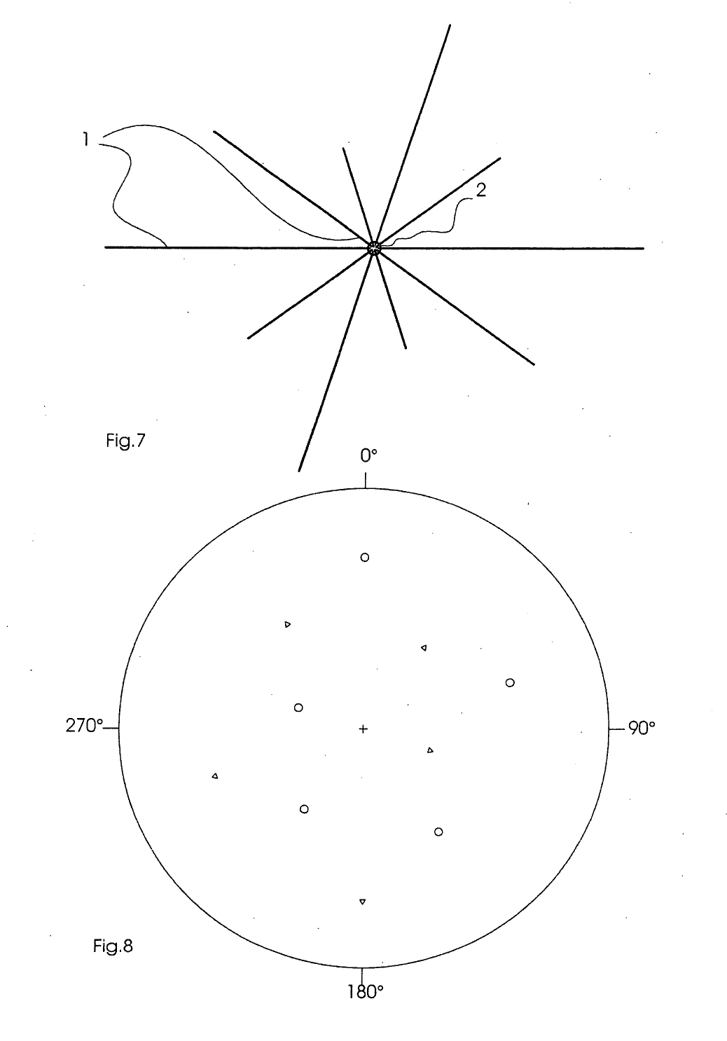

FIGS. 3 to 5 show a first embodiment of a geothermal energy probe arrangement according to the invention, which includes a total of five geothermal energy probes 1 having identical length. FIG. 3 shows a side view and FIG. 4 a top view of the geothermal energy probe arrangement of the invention, whereas FIG. 5 shows a stereographic projection in a Schmidt grid (lower half sphere). Shown here are the points of penetration of the individual geothermal energy probes 1 through an imaginary half sphere which extends from the ground surface into the ground. As can be seen in FIG. 5, the positional configuration of the geothermal energy probes 1 produces a spiral-shaped arrangement.

As illustrated in FIG. 3, the geothermal energy probes 1 are driven into the surrounding ground from a shaft 2 excavated in the ground. The first (flattest) of the geothermal energy probes has here a direction of 0° and an inclination angle of 30°. The clockwise next geothermal energy probe of the group has a spreading angle of 72° with respect to the previous geothermal energy probe and a differential inclination angle of 10°. This results in an inclination angle of 40°. This configuration of spreading angle and differential inclination angle between adjacent geothermal energy probes applies also to the other geothermal energy probes of the first group. This results in the following positional configuration: probe 1: 000/30 (direction angle/inclination angle); probe 2: 072/40; probe 3: 144/50; probe 4: 216/60; and probe 5: 288/70.

FIGS. 6 to 8 show diagrams corresponding to FIGS. 3 to 5 for a second embodiment of a geothermal energy probe arrangement according to the invention. In this embodiment, a total of ten geothermal energy probes 1 in groups of five are introduced into the ground in the manner according to the invention. As seen in the stereographic projection of FIG. 6, the five geothermal energy probes 1 of each of the two groups have a spiral-shaped arrangement, wherein the two spirals are intertwined. In agreement with the diagram of FIG. 5, the points of penetration of the geothermal energy probes 1 of the first group are shown as points, whereas the points of penetration of the geothermal energy probes 1 of the second group are shown as triangles.

Like with the exemplary embodiment of FIGS. 3 to 5, the flattest of the geothermal energy probes of the first group is installed in the direction 0° and with an inclination angle of 30°. The clockwise next geothermal energy probe of the same group has a spreading angle of 72° with respect to the previous geothermal energy probe and a differential inclination angle of 10°. This results in an inclination angle of 40°. This configuration of spreading angle and differential inclination angle between adjacent geothermal energy probes also applies to the other geothermal energy probes of the first group and also to the probes of the second group, wherein the flattest geothermal energy probe of the second group is also installed with an inclination angle of 30°, but in a direction of 180°. This results in the following positional configuration: probe 1: 000/30 (direction angle/inclination angle); probe 2: 072/40; probe 3: 144/50; probe 4: 216/60; and probe 5: 288/70; probe 6: 180/30 (direction angle/inclination angle); probe 7: 252/40; probe 8: 324/50; probe 9: 036/60; and probe 10: 108/70.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for installing geothermal energy probes, comprising introducing at least a first group having two to five geothermal energy probes into the ground from a starting point in a radial direction with a horizontal spreading angle between adjacent geothermal probes of at least 72° and a differential inclination angle between adjacent geothermal probes of at least 10°, wherein the differential inclination angle continuously increases or decreases from one geothermal probe of the first group to the next.

2. The method of claim 1, wherein the spreading angle between adjacent geothermal energy probes of the first group is selected to be equal to 360° divided by a number of the geothermal energy probes of the first group.

3. The method of claim 1, wherein an inclination angle of the geothermal energy probes of the first group relative to a ground surface is between 30° and 70°.

4. The method of claim 1, further comprising introducing a second group having two to five geothermal energy probes into the ground from the starting point in a radial direction with a horizontal spreading angle between adjacent geothermal probes of at least 72° and a differential inclination angle between adjacent geothermal probes of at least 10°, wherein the differential inclination angle continuously increases or decreases from one geothermal probe of the second group to the next.

5. The method of claim 4, wherein the spreading angle between adjacent geothermal energy probes of the second group is selected to be equal to 360° divided by a number of the geothermal energy probes of the second group.

6. The method of claim 4, wherein an inclination angle of the geothermal energy probes of the second group relative to a ground surface is between 30° and 70°.

7. The method of claim 4, wherein the horizontal spreading angle between the geothermal energy probes of the first group having a smallest inclination angle relative to the ground surface and of the second group having the smallest inclination angle relative to the ground surface is 180°.

8. The method of claim 1, wherein a total length of the geothermal energy probes is determined for usage of five geothermal energy probes based on a predetermined energy requirement.

9. The method of claim 1, wherein the geothermal energy probes of the first group have different lengths, wherein the geothermal energy probes having a smaller inclination angle relative to the ground surface are shorter than the geothermal energy probes with a greater inclination angle of the first group.

10. The method of claim 1, wherein based on an average value for the length of the geothermal energy probes of the first group, the geothermal energy probes having smaller inclination angles relative to the ground surface are shorter with the respect to the average length value by about the same amount as the geothermal energy probes with greater inclination angles are longer

11. The method of claim 4, wherein the geothermal energy probes of the first or the second group, or both, have different lengths, wherein the geothermal energy probes of the first and/or second group having a smaller inclination angle relative to the ground surface are shorter than the geothermal energy probes with a greater inclination angle of the same group.

12. The method of claim 4, wherein based on an average value for the length of the geothermal energy probes of the first group and the second group, the geothermal energy probes having smaller inclination angles relative to the ground surface are shorter with the respect to the average length value by about the same amount as the geothermal energy probes with greater inclination angles are longer.

13. The method of claim 4, wherein a total length of the geothermal energy probes is determined for usage of ten geothermal energy probes based on a predetermined energy requirement.

14. A geothermal energy probe arrangement, comprising at least a first group of two to five geothermal energy probes extending in ground from a starting point in a radial direction with a horizontal spreading angle between adjacent geothermal energy probes of at least 72° and a differential inclination angle between adjacent geothermal probes of at least 10°, wherein the differential inclination angle continuously increases or decreases from one geothermal probe of the first group to the next.

15. The geothermal energy probe arrangement of claim 14, wherein the spreading angle between adjacent geothermal energy probes of the first group is selected to be equal to 360° divided by a number of the geothermal energy probes of the first group.

16. The geothermal energy probe arrangement of claim 14, wherein an inclination angle of the geothermal energy probes of the first group relative to a ground surface is between 30° and 70°.

17. The geothermal energy probe arrangement of claim 14, further comprising a second group of two to five geothermal energy probes extending in the ground from the starting point in a radial direction with a horizontal spreading angle between adjacent geothermal energy probes of at least 72° and a differential inclination angle between adjacent geothermal probes of at least 10°, wherein the differential inclination angle continuously increases or decreases from one geothermal probe of the second group to the next.

18. The geothermal energy probe arrangement of claim 17, wherein the spreading angle between adjacent geothermal energy probes of the second group is selected to be equal to 360° divided by a number of the geothermal energy probes of the second group.

19. The geothermal energy probe arrangement of claim 17, wherein an inclination angle of the geothermal energy probes of the second group relative to a ground surface is between 30° and 70°.

20. The geothermal energy probe arrangement of claim 17, wherein the horizontal spreading angle between the geothermal energy probes of the first group having a smallest inclination angle relative to the ground surface and of the second group having the smallest inclination angle relative to the ground surface is 180°.

21. The geothermal energy probe arrangement of claim 14, wherein a total length of the geothermal energy probes is determined for usage of five geothermal energy probes based on a predetermined energy requirement.

22. The geothermal energy probe arrangement of claim 17, wherein a total length of the geothermal energy probes is determined for usage of ten geothermal energy probes based on a predetermined energy requirement.

23. The geothermal energy probe arrangement of claim 14, wherein the geothermal energy probes of the first group have different lengths, wherein the geothermal energy probes having a smaller inclination angle relative to the ground surface are shorter than the geothermal energy probes with a greater inclination angle of the first group.

24. The geothermal energy probe arrangement of claim 17, wherein the geothermal energy probes of the first or the second group, or both, have different lengths, wherein the geothermal energy probes of the first and/or second group having a smaller inclination angle relative to the ground surface are shorter than the geothermal energy probes with a greater inclination angle of the same group.

25. The geothermal energy probe arrangement of claim 17, wherein based on an average value for the length of the geothermal energy probes of the first group and the second group, the geothermal energy probes having a smaller inclination angle relative to the ground surface are shorter with the respect to the average length value by about the same amount as the geothermal energy probes with greater inclination angles of the same group are longer.

26. The geothermal energy probe arrangement of claim 14, wherein based on an average value for the length of the geothermal energy probes of the first group, the geothermal energy probes having a smaller inclination angle relative to the ground surface are shorter with the respect to the average length value by about the same amount as the geothermal energy probes with greater inclination angles are longer.
